(19) United States
(12) Patent Application Publication
(10) Pub. No.: US 2022/0306380 A1
(43) Pub. Date: Sep. 29, 2022

(54) CONTAINER FOR THE COLLECTION OF URBAN WASTE

(71) Applicant: OCEAN KUBE ENVIRONMENT, S.L., Pontevedra (ES)

(72) Inventor: Javier Jesús MARTIN HERRERO, Salamanca (ES)

(21) Appl. No.: 17/596,662

(22) PCT Filed: May 20, 2020
(86) PCT No.: PCT/ES2020/070327

§ 371 Date: Dec. 16, 2021

(30) Foreign Application Priority Data
Jun. 17, 2019 (ES) U201931013

(51) Int. Cl. B65F 1/14; B65F 1/16

(52) U.S. Cl. CPC B65F 1/1415; B65F 1/163; B65F 1/1646; B65F 1/1473; B65F 1/1421; B65F 2250/106; B65F 2230/126; B65F 2220/106

(57) ABSTRACT

A container for the collection of urban waste, constituted by an aluminium supporting structure which houses and protects a cardboard container, comprising: a supporting structure comprised of an external enveloping skeleton which is U-shaped when viewed from the side, with a removable upper hoop which closes the upper part of the envelope; a removable lid which folds with regard to the hoop which closes the skeleton assembly; a pedal located at the lower part and which operates the folding lid; and a tray which collects the leachates coming from a cardboard container, and which is a removable tray located upon the base; and a container, formed by folding a sheet of cardboard, resting upon the tray of the structure, and where the upper part of the container is held closed by the upper hoop of the structure.

### FIELD OF THE INVENTION

The present invention consists of a new type of container intended for the collection of urban waste, having a particular structure which facilitates handling by operators and its operability in waste collection with trucks, in addition to having a structure which makes the manufacturing and storage thereof easier when it is not in use. Additionally, the invention consists of an assembly manufactured with recyclable materials, which presents an environmental advantage in terms of recycling and reusing the components of said container.

The field of application of the present invention relates to different types of containers, preferably to the type of containers located in public roads for the pick-up and collection of urban waste, where these containers can be both stationary and movable containers.

### STATE OF THE ART

Conventional collection containers are known to be made of plastic material, for example, HDPE, and to present advantages such as the elimination of bad odours as well as being extremely impermeable to waste in liquid state. However, like any plastic element, this type of containers presents problems in terms of their cleaning and maintenance. In terms of cleaning the receptacle, returning said receptacle to acceptable health conditions is complex and costly, generally requiring chemical products and a large amount of water. Moreover, these containers are known to break or wear away both due to the use thereof and due to other acts of nature not related to the use of the container, which entails a high replacement cost as well as environmental problems in some cases, and therefore known conventional containers have a high maintenance cost.

Taking these problems into account, containers in which their structure or a part thereof comprise recyclable storage elements, and which, after several uses, can be disposed of and exchanged for new ones are known, and specifically solutions in which the receptacle is manufactured with cardboard are known. The inclusion of recyclable parts in a container presents advantages with respect to conventional containers the structure of which is based on plastic materials alone. Among the different types of containers comprising recyclable materials, structures with different shapes stand out. For example, the existence of cardboard containers having a cylindrical configuration is known; document ES2021254 discloses a parallelepiped-shaped cardboard container; or document EP2418156 discloses a container with a prismatic configuration. Other types of containers, based on a structure made of recyclable materials, which present improvements in terms of including different areas, storage zones, or compartments within the receptacle, are also known.

In any case, compared to plastic containers, containers in which the receptacle is made of recyclable material, particularly cardboard, presents the advantages of this material being able to be replaced every time it gets dirty, wears out, or when a decision is made to change the image, so savings are also achieved in the use of container-washing tanker trucks, mains water, detergents, or the purification of said dirt; a recyclable material is introduced which, when removed from the container, can be used to manufacture a new cardboard, or can be disposed of with the same waste for composting if it has become dirty with organic waste; and the printing of logotypes on the faces of the container is simplified and the possibility of a high-quality print that can be regularly replaced is expanded, where the possibility of having a new point for communicating ideas, environmental adaptation, advertising, or any type of campaigns of public or private entities, can therefore be opened up.

These solutions based on structures made of recyclable material, particularly cardboard, present a stability and strength problem. There is a need to take into account that the entire container is subjected to the actual manual handling forces of the user, may be subjected to the forces of collection trucks which lift and shake it in the air, and furthermore subjected to the weight and movement of the actual products stored in the receptacle which hit against the walls thereof. Therefore, containers the structure of which is based on recyclable materials, particularly cardboard containers, present a stability problem.

The disclosure of document ES1214555U, which can be considered the closest state of the art, describing a type of container with a metal frame and a cardboard container, providing improvements to stability and strength problems defined above, is known at this point; however, this solution has a rigid structure which is not versatile and, among others, presents the problems of not allowing the storage thereof or of having to replace the entire frame in the event that one of the parts thereof breaks. Compared to this solution, the present invention describes a container the structure of which is more versatile and allows different structures and/or frames to be stored, which also constitutes a clear advantage in terms of distribution in the city or in the area of interest, and presents a modular solution in which the different parts can be assembled and disassembled, presenting an advantage in maintenance. Additionally, the present invention has a receptacle structure that is different from this prior art.

In view of the problems related with waste collection containers and of the solutions and prior arts known in the state of the art, the present invention describes a container which presents improvements in terms of versatility and maintenance possibility, with the assembly being stable and resistant at the same time to the actions and stresses it is subjected to both by operators and by the waste itself, and which furthermore incorporates a receptacle that is completely recyclable.

### DESCRIPTION OF THE INVENTION

The invention consists of a container for the collection of urban waste which is constituted by two main parts, an aluminium supporting structure and envelope, and a cardboard container fitted in the supporting structure. Therefore, this container is constituted by reusable materials, which constitutes an environmental advantage, and in turn, all its elements are removable, which in turn constitutes an advantage for the stacking and storage thereof.

The container object of the present invention comprises:
an aluminium supporting structure which is a skeleton which houses and protects a cardboard container, and wherein the supporting structure comprises:
   an external enveloping skeleton constituted by a front wall, a base, and a rear wall, which is U-shaped when viewed from the side;
   a removable hoop which closes the upper part of the envelope;
   a removable lid which folds with regard to the hoop hexagonal which closes the skeleton assembly;
   a pedal located at the lower part of the base of the envelope which, together with a lever running along both the base and the rear wall of the envelope, operates the folding lid; and
   a tray located upon the base of the envelope for collecting leachates coming from the cardboard container, the tray being removable with respect to the base; and
a cardboard container which is housed and supported by the supporting structure; which is formed from a sheet of cardboard with folded planar faces forming a regular parallelepiped open at the upper part thereof, with a base and an upper part having an identical geometric shape; and wherein the base of the container is located upon the tray of the structure, and wherein the upper part of the container is held closed by the upper hoop of the structure.

Container variants adapted to different needs are contemplated in embodiments of the invention: a box with a rectangular base and a hexagonal upper part with standard capacity and surface with less folds and better visibility of the print; and a box with a hexagonal base and upper part, with extended capacity, both compatible with the supporting structure. In other words, the container can have a hexagonal geometric shape in the base of the container, the tray, and the upper hoop; or it can have a rectangular geometric shape in the base of the container and the tray is rectangular; whereas the upper hoop is hexagonal.

In more detail, the folding lid preferably has a circular section with a handle which allows it to be manually lifted. This lid is attached to the ring of the enveloping structure by means of a spring hinge which allows a smooth and adjustable closure.

In the front part of the structure, specifically in its front wall, a bar is arranged for trucks or other mechanical collection means to lift the container.

As set forth above, there is arranged in the inner part of the base of the structure a waterproof tray which is removable and can be made of cardboard or aluminium, designed for fixing the lower face of the cardboard container and retaining possible liquids coming from the waste. This tray is attached with both the base and the container with a biodegradable adhesive.

The outer front part of the lower part of the base has a pedal which allows opening the lid by pushing it with the foot. The pedal is in connection with a lever running along the lower portion of the base and the inside of the rear wall and protruding from the hoop by way of a flange, such that it is entirely concealed from view and such that the lid is pushed when the pedal is operated. This pedal returns to its initial position when the force is no longer applied.

The container contacts the ground by means of wheels that are preferably manufactured in aluminium and rubber, allowing the container to be moved easily. These wheels are preferably located in the rear part of the assembly and attached to the enveloping structure. Additionally, the invention comprises in the front part of the structure legs which allow the fixing of the assembly and may comprise a non-slip surface that prevents the container from sliding on slopes.

In the rear part, specifically in the rear wall, the assembly has at least one handle or knob for manually handling the container in all directions in a safe and comfortable manner.

The cardboard container is made up of an assembly of folded planar faces which rests upon the lower tray and is fitted in the upper ring, such that the edge thereof is protected from external agents.

The outer side faces of the container are visible with there being no obstructions of the structure, and this allows the use thereof as an advertising, promotional, or information support.

In addition to the bar-type lifting system in the front wall of the structure, the container may comprise protruding side rods fixed in the structure, preferably to both sides of the upper hoop, such that it allows the container to be lifted by means of a rear or side loading system.

In order to complete the description and to help a better understanding of the features of the invention, a set of figures and drawings is presented wherein the following is represented by way of illustration and not limitation:

FIG. 1 is a free perspective view of the assembly of the container object of the present invention in which the lid is open and allows waste to be introduced in the cardboard container.

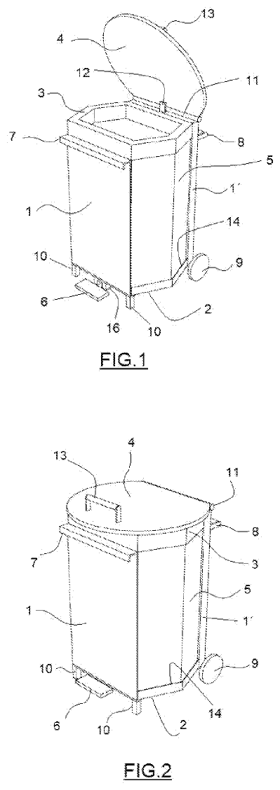

FIG. 2 is a perspective view of the assembly of the preceding figure in which the lid closes the supporting structure which houses the cardboard container.

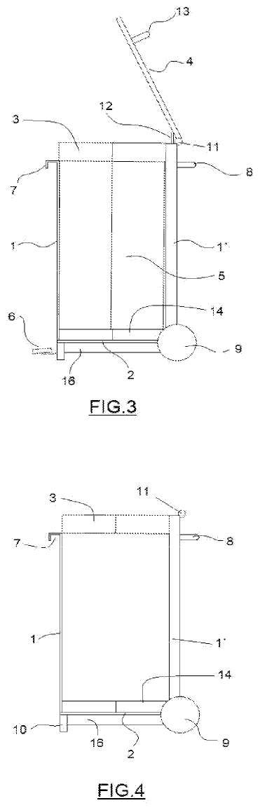

FIG. 3 is a side view of the assembly of the container in which the lid is open.

FIG. 4 is a side view of the assembly of the container in which the lid has been removed.

FIG. 5 is a free perspective view of the assembly of the preceding figure in which the lid has been removed and waste can be directly thrown into the container.

FIG. 6 is a perspective view of the removable tray located upon the base of the enveloping structure of the container and the purpose of which is to collect possible leachates leaking from the container.

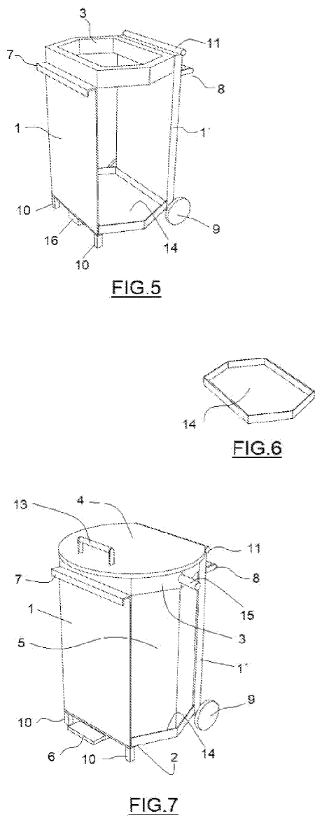

FIG. 7 is a perspective view of the assembly of the container comprising side rods to enable the lifting thereof by means of a rear or side loading system.

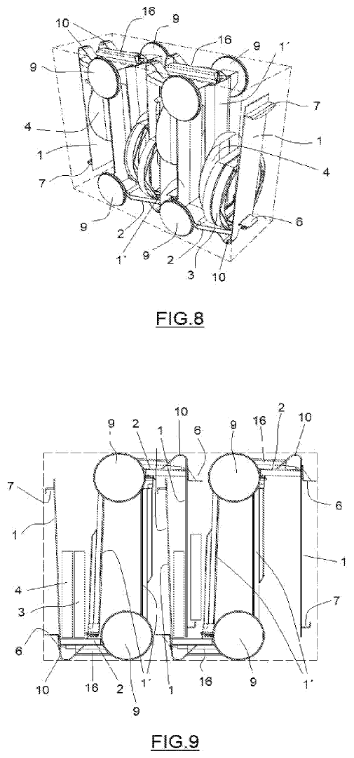

FIG. 8 is a perspective view of an assembly of containers which are stacked and stored in a small space.

FIG. 9 is a side view according to the preceding figure in which an assembly of stacked and stored containers is seen.

### DETAILED DESCRIPTION OF THE FIGURES OF THE INVENTION

FIGS. 1-7 show that the invention consists of a container comprising a supporting structure and an envelope, and a cardboard container fitted in the supporting structure. Although it cannot be seen in said figures, this container is entirely constituted by reusable materials, both in terms of the structure which is preferably made of aluminium, and in terms of the container which is made of cardboard. An aspect that is indeed depicted in said figures is that all its elements are removable, which in turn constitutes an advantage for the stacking and storage thereof. In this sense, an example of the storage of different containers can be seen in FIGS. 8 and 9, for which the different elements comprised in the containers must essentially be removable.

As can be seen in said figures, the container comprises:
a supporting structure which is a skeleton which houses and protects a container (5), and wherein the supporting structure comprises:
   an external enveloping skeleton constituted by a front wall (1), a base (2), and a rear wall (1′), which is therefore U-shaped when viewed from the side;
   a removable upper hoop (3) which closes the upper part of the envelope;
   a removable lid (4) which folds with regard to the hoop (3) which closes the skeleton assembly;
   a pedal (6) located at the lower front part of the base (2) of the structure which, together with a lever (16) running along both the base and the rear wall of the envelope, operates the folding lid (4); and
   a removable tray (14) located upon the base (2) of the envelope for collecting the leachates coming from the cardboard container (5); and
a cardboard container (5) which is housed and supported by the supporting structure; which is formed from a sheet of cardboard with folded planar faces forming a regular parallelepiped open at the upper part thereof, with a base and an upper part having an identical geometric shape; and wherein the container (5) rests on the tray (14) of the structure, and wherein the upper part of the container is held closed by the upper hoop (3) of the structure.

As can be seen in FIGS. 1-7, in a preferred embodiment of the invention, the tray (14), the hoop (3), as well as the base and the upper part of the container (5) are hexagonal; nevertheless, there are other embodiments in which the tray and the base are rectangular, whereas the hoop is hexagonal. Similarly, the lid (4) preferably has a circular section with a handle (13) which allows it to be manually lifted. This lid (4) is attached to the hoop of the enveloping structure by means of a spring hinge (11) which allows a smooth and adjustable closure.

Among the different lifting means of the invention, it can be seen in said figures that there is arranged in the front wall (1) a bar (7) for trucks or other mechanical collection means to lift the container from the front. Furthermore, it can be seen in FIG. 7 that the invention may further comprise protruding side rods (15), fixed to both sides of the upper hoop (3), such that it allows the container to be lifted by means of a rear or side loading system.

Another aspect of the invention is that a pedal (6) which allows opening the lid (4) by pushing it with the foot is arranged in the outer front part of the base (2).

FIG. 1 or 3 shows how the pedal is operated and therefore the lid (4) is open; however, for example, FIG. 2 or 7 shows that the pedal (6) is not operated and therefore the lid (4) is closed. The pedal (6) is in connection with a lever (16) running along the lower portion of the base (2) and the inside of the rear wall (1′) and protruding from the upper hoop (3) by way of a flange (12), such that it is entirely concealed from view and such that the lid (4) is pushed when the pedal (6) is operated.

As can be seen in said figures, the container contacts the ground by means of wheels (9) which allow the container to be readily moved. There is at least one handle or knob (8) arranged in the rear wall (T) for handling the container in all directions in a safe and comfortable manner. Additionally, the invention comprises in the front part of the structure legs (10), which can be in multiple shapes, which allow the fixing of the assembly, and may comprise a non-slip surface that prevents the container from sliding on slopes.

Another particularity of the invention shown in the figures is that the invention allows the container (5) to be used for advertising, promotional, or information purposes. The container (5) is formed by a folded sheet of cardboard, such that any type of advertising, promotional, or information message can be reproduced on the outer faces of said cardboard. In this sense, the outer side faces of the container are visible given that there are no obstructions of the structure.

Lastly, it can be seen in FIGS. 8 and 9 that one of the advantages of this invention lies in the fact that these containers are readily stackable and storable. This is an advantage in terms of their distribution and storage. To that end and as set forth above, the structure of the container comprises a U-shaped side configuration which allows the front walls (1), rear walls (1′), and bases (2) to be stacked with two containers facing each other. Given that both the upper hoops (3) and the lids (4) are removable, these elements and any other element of the structure can be stored between the front and rear faces of two stacked containers. Similarly, the rest of the elements, such as the trays (14) or the containers (5), can be stored independently given that they are removable with respect to the structure. This allows taking advantage of and optimising storage space, such that two disassembled containers can be stored in the space for an assembled container.

1. A container for the collection of urban waste constituted by an aluminium supporting structure which houses and protects a cardboard container, wherein the container comprises:
a supporting structure comprising:
an external enveloping skeleton constituted by a front wall, a base, and a rear wall, which is U-shaped when viewed from the side;
a removable upper hoop which closes the upper part of the envelope;
a removable lid which folds with regard to the hoop which closes the skeleton assembly;
a pedal located at the lower front part of the base, in connection with a lever running along the base and along the rear wall of the envelope, and which operates the folding lid; and
a tray which collects the leachates coming from a cardboard container, and which is a removable tray located upon the base; and
a container formed by folding a sheet of cardboard with planar faces forming a regular parallelepiped open at the upper part thereof, wherein the container rests on the tray of the structure, and wherein the upper part of the container is held closed by the upper hoop of the structure; and wherein the geometric shape of the base of the container coincides with that of the tray.

2. The container for the collection of urban waste according to claim 1, wherein the geometric shape of the base of the container, the tray, and the upper hoop is hexagonal.

3. The container for the collection of urban waste according to claim 1, wherein the geometric shape of the base of the container and the tray is rectangular; and the upper hoop is hexagonal.

4. The container for the collection of urban waste according to claim 1, wherein the lid has a circular shape.

5. The container for the collection of urban waste according to claim 1, wherein the lid comprises a handle.

6. The container for the collection of urban waste according to claim 1, wherein the lid is attached to the hoop of the structure by means of a spring hinge.

7. The container for the collection of urban waste according to claim 1, wherein the lever protrudes from the upper hoop by means of a flange.

8. The container for the collection of urban waste according to claim 1, wherein the front wall comprises a bar for lifting the container.

9. The container for the collection of urban waste according to claim 1, wherein the upper hoop comprises protruding side rods for lifting the container, fixed to both sides of the hoop.

10. The container for the collection of urban waste according to claim 1, wherein the supporting structure comprises wheels in the lower part thereof.

11. The container for the collection of urban waste according to claim 1, wherein the rear wall comprises at least one handle or knob.

12. The container for the collection of urban waste according to claim 1, wherein the supporting structure comprises legs in the lower part thereof.

13. The container for the collection of urban waste according to claim 12, wherein the legs comprise a non-slip surface.
